(19) United States
(12) Patent Application Publication
(10) Pub. No.: US 2025/0168166 A1
(43) Pub. Date: May 22, 2025

(54) SYSTEM AND METHOD FOR A CONNECTIVITY PLATFORM AND REMOTE MANAGEMENT

(71) Applicant: Capgemini SemiConnext Platform BV, Utrecht (NL)

(72) Inventors: Bernard Drost, Laren (NL); Tony Edwards, Surrey (GB); Robert Soeting, Vianen (NL); Mathias Wilhelm, Bad Bellingen (DE)

(73) Assignee: Capgemini SemiConnext Platform BV, Utrecht (NL)

(21) Appl. No.: 18/954,862

(22) Filed: Nov. 21, 2024

Related U.S. Application Data
(60) Provisional application No. 63/601,476, filed on Nov. 21, 2023.

(51) Int. Cl. H04L 9/40

(52) U.S. Cl. CPC H04L 63/0884

(57) ABSTRACT

A system and method providing a secure, scalable, reliable, and transparent connectivity platform between an Original Equipment Manufacturer (OEM) side and OEM customer production plants (FAB) side. The zero-trust architecture facilitates the transport of data to and from equipment located on the FAB side and provides access for service engineers, for example, to remotely operate the equipment. The connectivity platform includes a plurality of innovative networking applications to provide secure access to authorized users.

The application claims priority to U.S. Provisional Application No. 63/601,476, entitled SYSTEM AND METHOD FOR A CONNECTIVITY PLATFORM AND REMOTE MANAGEMENT, filed on Nov. 21, 2023, all of the contents of which are hereby incorporated by reference.

### BACKGROUND OF THE INVENTION

The global economy has presented opportunities for organizations to work together regardless of physical and geo-political borders. Developments in network technologies, such as virtual private networks and remote desktop virtualization, have reduced the barriers for collaborative development. However, conventional remote access technologies often leave organizations vulnerable to security breaches and other risks. Without proper security measures, remote connections can provide a gateway for cybercriminals to gain unauthorized access to devices, modify and steal sensitive data. The vulnerabilities stem from weak user authentication policies, unsecured networks, lack of visibility into remote user activity and lack of physical security controls.

Attempts to solve this problem have fallen short. Traditional policies merely encourage users to not share their credentials or use weak passwords. Often virtual private networks are employed and advanced antivirus tools are installed. But these solutions still permit a direct connection to devices with little or no oversight. With a single connection, an intruder may obtain complete access to a network, applications and the files residing thereon.

For example, Original Equipment Manufacturers (OEMs) and fabrication plants (FABs) often need to communicate in a secure manner. In some scenarios, OEM engineers will need to remotely access equipment at the FAB plant to provide a FAB side engineer with the technical specifications for a particular piece of equipment produced by the OEM. And since the OEM side and FAB side are on different enterprise networks, it is difficult to establish a connection between the two without creating a vulnerability. More specifically, there is a need for OEM engineers to connect to equipment on the FAB side securely and reliably.

Effective remote access can also support an organization's sustainability efforts. For example, the remote access technologies described herein can reduce the amount of time individuals spend traveling, reducing the use of fossil fuels and greenhouse gas emissions. Furthermore, innovative technologies which permit this type of collaborative effort can reduce the demand on power grids by reducing the amount of office space needed in larger markets and thereby reducing the amount of electricity needed to power the lighting and HVAC systems to those office spaces.

### SUMMARY OF THE INVENTION

The Connectivity platform provides secure, scalable, reliable, and transparent connectivity between Original Equipment Manufacturer (OEM) locations and OEM customer production plants (FABs). It facilitates the transport of data to and from Equipment located in a FAB and provides access for service engineers, for example, to remotely operate the Equipment. Preferably, this access is limited to authorized individuals and for authorized activities. The platform supports multi-tenancy, providing the service to multiple OEMs and multiple FABs while protecting FAB and OEM data privacy and intellectual property rights. The Connectivity platform may be managed by a service provider which may be independent from the OEMs and FABs that use it. Although the various embodiments may be discussed herein relative to OEMs and FABs, it is understood that the inventions described herein are applicable generally and are therefore not limited.

A few of the exemplary services include: Remote Take Over (RTO), Remote Command Execution (RCE), File Transfer, Security and Audit. In one embodiment, Remote Take Over allows the OEM engineer to take over the front-end of a machine located in a FAB. The RTO may be implemented using remote management tools such as Virtual Network Computing (VNC) and Remote Desktop Protocol (RDP). Remote Command Execution allows the OEM engineer to execute operating system commands at the machine located in the FAB. Preferably, the OEM is not connected directly to the FAB. That is, all exchanges between the OEM and the FAB pass through an intermediate service, e.g., a secure access service, which implements the zero-trust policy discussed herein. The Remote Command Execution commands may be restricted to a defined set of commands including a restricted set of command attributes and options. File Transfer allows the OEM engineer to transport files from and to the FAB. Preferably, files transported from the FAB may include log files and anonymized data files. Files transported to the FAB may include machine configuration data and software packages, updates and patches. The Equipment may include a plurality of applications, application files, etc. In this regard, the system may further restrict access to certain applications and to certain application data files, even when access to the given application has been granted. For example, the OEM user may be given access to control a data analytics application on the remote machine, but not certain files based on file type, or some other metadata associated with the file, including analytics data file types. In this regard, a remote IT person, for example, can RTO a device for application maintenance, but that person would not be able to access the application files that may contain confidential and/or highly sensitive information. Security and audit include processing activities which are logged and cannot be altered by the executing engineer. In one embodiment, data may leave the FAB only if properly authorized by a FAB engineer. Access to the Connectivity platform may be granted based on the federated Identity provider (IdP) of the OEM and FAB. Access of a given user or user group to certain equipment is controlled via Defined Permission Sets (DPS).

Additional aspects of the present invention will be apparent in view of the description which follows.

### BRIEF DESCRIPTION OF THE FIGURES

FIG. 1 is one embodiment of a network configuration for the Connectivity platform;

FIG. 2 is one embodiment of a network configuration for the Connectivity platform;

FIG. 3 is one embodiment of a network configuration for the Connectivity platform;

FIG. 4 is one embodiment of the software architecture for the Connectivity core;

FIG. 4A is an embodiment of an interface for the Connectivity platform.

FIG. 5 is a front view of an interface for the Connectivity platform;

FIG. 6 is a front view of an admin interface for the Connectivity platform;

FIG. 7 is an example flow diagram of the connecting platform

FIG. 8 is an example flow diagram of the equipment access process;

### DETAILED DESCRIPTION OF THE INVENTION

The present invention(s) is/are described in the following examples, which are set forth to aid in the understanding of the invention and should not be construed to limit in any way the scope of the invention as defined in the claims which follow thereafter.

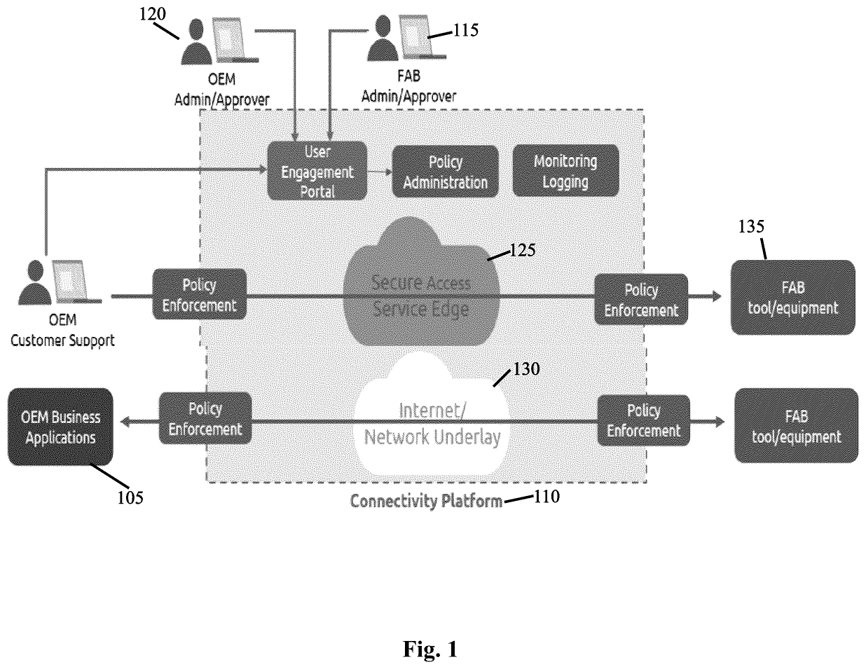

FIG. 1 is one embodiment of a network configuration for the Connectivity platform. The Connectivity platform 110 illustrated in FIG. 1 includes OEM business applications 105, connected to FAB tools and equipment 135 over the Internet/Network Underlay 130. Although an Internet/Network Underlay 130 is shown, it is understood that other networks or combinations of network types may be used. The FAB equipment may include one or more applications, as well as related files, including system and other types of files. The Connectivity platform uses a secure access service/server(s) 125, e.g., the edge service or simply the FAB Edge, to implement policy enforcement between OEM customers and FAB equipment, including a policy based on the zero-trust principle, as discussed herein. Users may include an OEM Admin/Approver 120, a FAB Admin/Approver 115 and OEM customer support. Interactions between these entities may occur through the User Engagement Portal. Through the user engagement portal, policy administration, policy enforcement, monitoring, and logging may be accomplished.

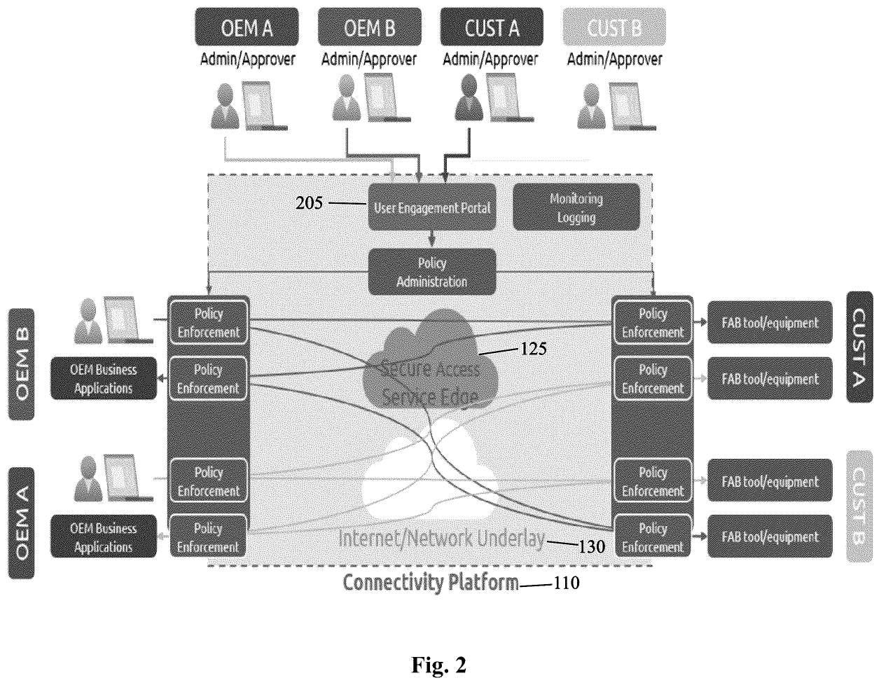

FIG. 2 is one embodiment of a network configuration for the Connectivity platform. The Connectivity platform illustrated in FIG. 2 illustrates multiple OEM side users (OEM A and OEM B) and FAB side users (which may be the OEM's customers) accessing the user engagement portal. In one embodiment, the OEM side users and FAB side users may include one or more users possessing administrator and/or approver roles. Once accessed, the user engagement portal utilizes policy enforcement protocols to establish a connection between the OEM users and the FAB tool/equipment/applications/files. Similarly, the FAB side engineers (Cust A and Cust B) may control access to the FAB side equipment through similar policy enforcement protocols. Moreover, one or more chaperones may access the platform to oversee in real time the RTO/RCE, etc., of the FAB equipment, for example.

The Connectivity platform 110 may include three main components: 1) a central user portal 205 that manages access requests from authorized users, 2) a core platform component which contains the central functions and integration capabilities of the service, and 3) one or more Edges at OEM locations and/or FAB locations for accessing OEM Equipment.

The central user portal 205 acts as the single “one-stop” entry point for requesting remote access, executing remote commands, and defining file transfer schedules at the Edges. The portal holds workflows for approvals and functionalities for: Remote Take Over (RTO), Remote Command Execution (RCE), file browsing, file transfer, web proxy, Defined Permission Sets (DPS) management, and/or user administration (such as add/remove). In one embodiment, the central user portal provides the workflows to manage the users of the Connectivity platform, which are not identified via the federated IdP. The central user portal may further provide the workflows to manage access permissions, their grouping into permission groups and the assignment of permission groups to Defined Permission Sets (DPS). Through the central user portal, authorized users can also submit a request for assistance when experiencing problems when requesting access to, or accessing, OEM equipment. In one embodiment, the central user portal also enables approval flow for items that either need OEM or FAB Approval, like file transfer schedules, Permissions, and/or other items.

The core platform is the main orchestration layer managing RTO, RCE, file transfer, web proxy and security and audit. This core may be located in a public cloud, and it enforces the zero-trust principle for services consumed through the platform, as discussed herein. In conjunction with the Connectivity core, an API may provide a generic REST API to interact with the Connectivity platform to authenticate, validate users, customers, equipment, and log requests for access.

In one embodiment, the FAB Edge is the environment deployed near a FAB, where near may be understood in terms of proximal network connectivity. The FAB Edge supports the zero-trust interface to the OEM engineer and connects to the OEM equipment in the FAB. In one embodiment, the OEM Edge is the environment deployed within the OEM environment to accommodate file transfers to/from the OEM self-managed file landing zone (or cloud destination). The Connectivity platform 110 may utilize an existing internet connection of the OEM and the FAB. Optionally, a network underlay service, such as an SD-WAN, provides a dedicated network connection between the OEM and the FAB, orchestrated by the Connectivity Core.

The overall system utilizes repeatable integration controls between vendor products, utilizing constructed coding and interfaces that provide a comprehensive policy using the zero-trust principle, allowing the Platform to co-exist and federate with an OEM and FAB. Pseudo access may be provided to the target systems, which provide role-based access controls (RBAC), alongside fine-grained privileges that the target systems may not possess. The combination of system features is adaptable to any industrial use where target systems with or without RBAC and fine-grained control require an integrated zero-trust mechanism. That is, the presumption is that users do not have access to the FAB and must request access each time access to the Equipment is desired. As noted above, access to equipment may be limited to authorized users.

In one embodiment, OEM service engineers will log in with their credentials (account/password) and authenticate themselves to their OEM IdP. At the onset, the OEM engineer will not have access to RTO/RCE, etc., and Equipment. The use of any particular piece of OEM equipment by a FAB may be confidential. As such, the information provided to the OEM engineer may be limited and/or anonymized. Thereafter, the OEM engineers make their requests for remote access, remote command execution or file transfer via the central user portal. This triggers approval flows towards OEMs and OEM Customers/FABs, either granting or denying access. After granting access, the option to access the equipment will be made available and the core platform provides a web-based browser link to the OEM service engineer, through which the OEM service engineer can access the equipment. The link may have an expiration, such as 30 minutes, for example. Consequently, an OEM service engineer can use the remote access functionality anywhere where public internet connectivity is available.

In one embodiment, the Connectivity platform is a multi-tenant platform designed to protect FAB and OEM data privacy and intellectual property rights. The core platform components may be advantageously designed to support multi-tenancy, i.e., core components serve multiple OEMs and FABs, whilst providing data segregation, so that a specific OEM service engineer can only view or update the subset of data that it is entitled by its organization to access. FAB Edge components also support multi-tenancy. In one embodiment, a FAB can use a single Edge instance to support all access functions provided by the service from multiple OEMs. One or more functions may be hosted on the same virtual or physical hardware. OEMs may be restricted to the specific equipment that they are authorized to access by the FAB.

FAB edge configuration may be configured in a variety of ways. At least one configuration is a physical FAB edge and the other is a cloud based virtual FAB edge. By default, the cloud FAB edge is the default way to connect to machines within a FAB. The physical FAB Edge may be utilized, if data stored in the FAB edge must reside in a FAB, so a cloud version is not feasible. In one embodiment, the physical FAB Edge is deployed into the network of the FAB, but isolated from the FAB network in a Connectivity platform De-Militarized Zone (DMZ) (e.g., via a set of inspection based firewall systems). Connection to the internet can either be enabled through an existing FAB internet facing DMZ and FAB ISP or through the optional network underlay connectivity provided by the Connectivity platform. The SD-WAN connectivity may be used for platform traffic.

As noted above, the default FAB connection is via a Cloud FAB Edge and an iVPN endpoint in the FAB from where the OEM equipment can be reached. This does not require any Connectivity platform specific hardware to be deployed and is the fastest way to connect a FAB to the Connectivity platform. The iVPN Endpoint and the routing to the OEM equipment within the FAB network may be provided by the FAB. In one embodiment, the Cloud Fab Edge consists of a set of virtual infrastructure and containers embedded between Firewalls and located in a public cloud environment. If a network underlay service is utilized, the FABs connected to that Edge, the network underlay appliance is deployed.

In one embodiment, the firewalls serve as an iVPN endpoint for connections to FABs. As such, the FAB utilizes a device that enables the FAB iVPN endpoint. In one embodiment, an optional endpoint can be deployed upon request if required. The Cloud Edge contains the software to authenticate connection requests and provides the interface and service inter-connections for: RTO, RCE, file transfer staging area for content inspection, web proxy to access web applications on the equipment in the FAB. In one embodiment, the Cloud Edge is multi-tenant, meaning that it can be used by multiple OEMs to connect to their managed equipment in the attached FABs.

OEM configuration may be accomplished in a variety of ways. In one embodiment, the OEM customer simply connects to the Connectivity platform via the Connectivity central user portal. In this regard, the OEM customer may connect through the OEM DMZ and Internet Service Provider (ISP) to the public internet and then to the Connectivity core, where the central user portal can be reached. For file transfer, the transfer scheduler and component of the Connectivity platform may be deployed locally to store files transferred by Connectivity platform from/to the OEM file store. They can either be sent through the OEM DMZ and ISP or through the optionally available network underlay service provided by Connectivity platform. In one embodiment, transfer of files can occur via Remote Access via the File-Browse & Download feature. This is at the OEMs discretion and governed by the Defined Permission Sets (DPS) es. The data security of a file transferred and stored in a location outside the Connectivity platform may be the responsibility of the OEM.

OEM configuration may also include a remote office site. The OEM Engineer remote office could be a location outside the OEM core location, such as an engineer's remote location as long as the engineer is authenticated against the OEM IdP. The file transfer still happens via the standard OEM Connectivity and the files are stored in the OEM file store after transfer, but the files are made available via an OEM provided replication mechanism to the admin site.

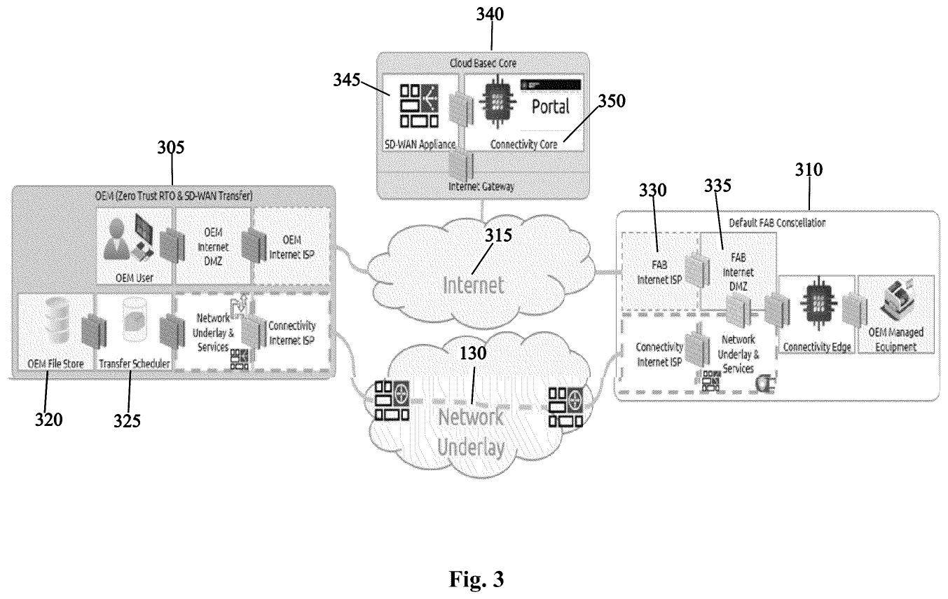

FIG. 3 is one embodiment of a network configuration for the Connectivity platform. The high level overview illustrated in FIG. 3 includes an OEM side 305 and a FAB side 310 connected via a network underlay 130 and/or the Internet 315. In one embodiment, the OEM side includes a zero-trust remote take over and SD-WAN transfer capabilities. Although additional connectivity techniques may be implemented, the OEM user may connect to the default FAB constellation over the Internet or through a network underlay. When connecting over the Internet, the OEM user may connect to an OEM Internet DMZ which may be understood as a perimeter network that protects and adds an extra layer of security to an organization's internal local-area network from untrusted traffic. The OEM User may connect to the OEM Internet ISP which provides access to the Internet and assists with establishing a connection to the FAB constellation. OEM users may continue the connection to the FAB side Internet ISP 330 and then to the FAB side Internet DMZ 335. Once those connections are established the OEM user may then connect to the FAB Connectivity Edge. The FAB connectivity edge may then provide galvanically separated access to FAB Equipment.

As can be seen in FIG. 3, the OEM side includes an OEM File Store 320 and a Transfer Scheduler 325. In addition, the OEM User may obtain access to the FAB constellation via a Network Underlay, Services and OEM Side Connectivity Internet ISP. The Network Underlay will provide access to the FAB side connectivity Internet ISP 330 and FAB Side Network Underlay & Services. The FAB connectivity edge may then provide galvanically separated access to FAB Equipment.

FIG. 3 further illustrates a Cloud Based Core 340. The Cloud Based Core includes an SD-WAN appliance 345 and a connectivity core 350. The Connectivity Core may further include a Connectivity Edge and User Portal.

In one embodiment, the OEM side includes an OEM enterprise network, file storage managed by the OEM, one OEM managed firewall interposed between the OEM enterprise network and a Connectivity network/DMZ. The Connectivity network may be in communication with the Connectivity platform scheduling virtual machines and a redundant firewall sitting on a network underlay. Two redundant ISPs may be in communication over the Internet to place the OEM in connection with the FAB side and vice versa. Like the OEM side, the FAB side may include a redundant firewall sitting on a network underlay which connects to the FAB Connectivity network. On the Connectivity network, edge appliances may be utilized to send unencrypted traffic through a single redundant FAB managed firewall leading to the FAB internal network and to the FAB equipment or tool.

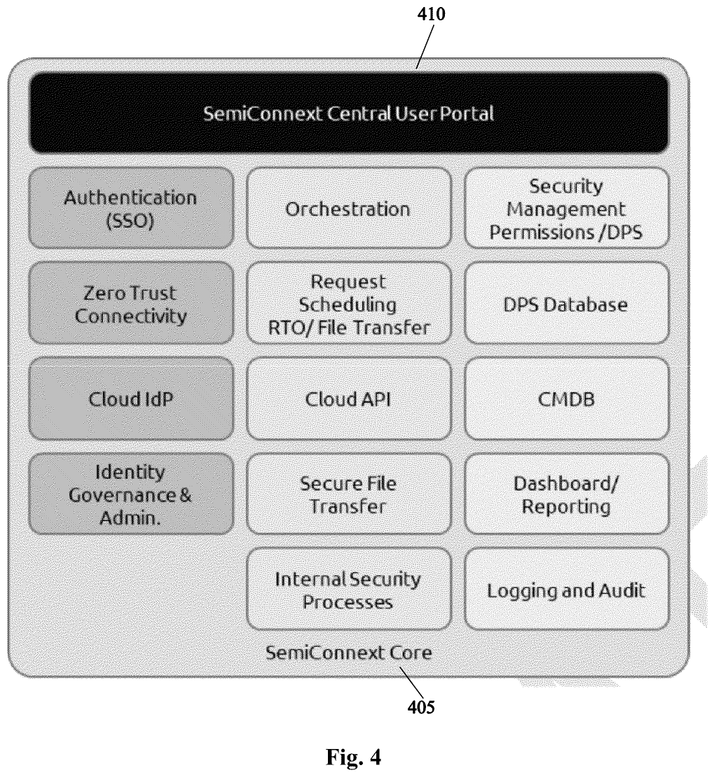

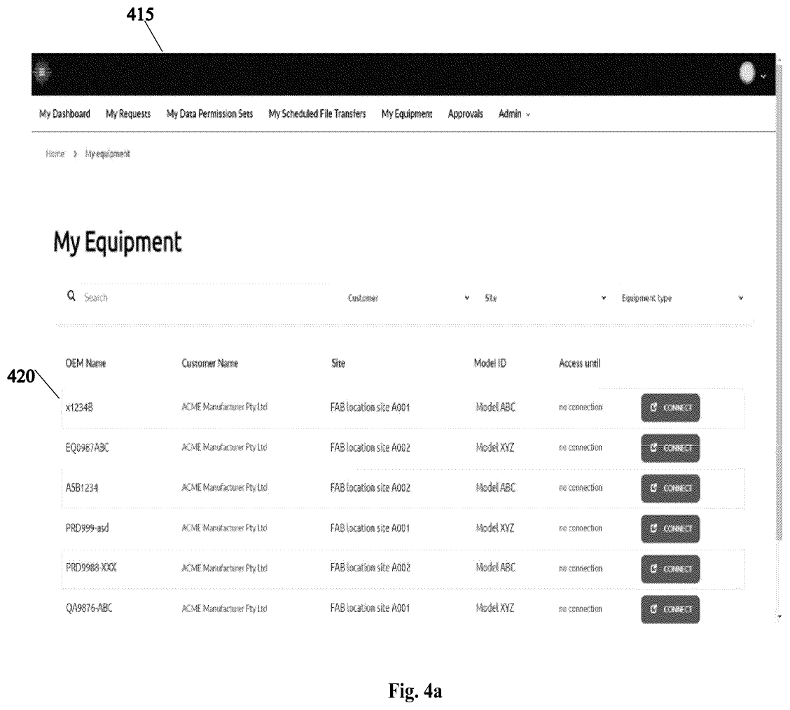

FIG. 4 is one embodiment of the software architecture for the Connectivity core 405. The Connectivity platform core may include a Connectivity central user portal 410. The software architecture depicted in FIG. 4 includes an authentication module, a zero-trust connectivity module, a cloud identity provider, or cloud IDP and an identity governance and administration module. The software architecture further includes an orchestration module, a request scheduling RTO/File Transfer module, a cloud API module, a secure transfer module and an internal security processes module. Additionally, the Connectivity core architecture includes a security management permissions/DPS module, a DPS database, a CMDB database, a dashboard/reporting module and a logging/audit module.

In one embodiment, the cloud-based central user portal provides a workflow managed system for administering access and requesting Connectivity platform services such as file transfer, remote connectivity for OEM service engineers to equipment (e.g., file browse, download, etc.), remote command execution, a Cloud API for the use by programmatic interfaces and applications at the OEM, scheduling function for planned data transfers, reporting on usage. The Connectivity core may implement privacy policies in a variety of ways. In one embodiment, the Connectivity core uses identity federation towards OEM and OEM Customers, (i.e., OEM explicit user identities are not stored within the Connectivity platform). Additionally, access and transfer permissions are defined by OEMs and OEM customer security officers. This permits OEM Customers to remain accountable for validating access or transfer.

Data security in the Connectivity platform may be established via secure connectivity for data to be transferred and files are directly transferred from FAB Edges to an OEM receiving server at an OEM landing zone; or vice versa, from the OEM landing zone to the FAB Edge. In one embodiment, data may be stored for an agreed period of time in-transit within the Edge for the purpose of FAB inspection and also anti-virus scanning. Secure connectivity may be accomplished encrypting traffic flows between FAB Edges and the core platform. In one embodiment, the connecting system may use IPSec VPNs over an Internet link as the default connectivity for FABs towards the Cloud Edge. In general, the Connectivity platform logs all activities executed. In one embodiment, the data retention of the logs may be customizable to a customer's security policies and country regulations. Furthermore, monitoring data (telemetry) may be obfuscated based upon OEM and FAB in-transit policies.

One of the core functions of the Connectivity platform is remote access. In one embodiment, an authorized user (e.g., OEM service engineer) makes a remote access request through the Connectivity central user portal. If the OEM service engineer chooses the equipment for which their account or their user group has pre-approved remote access permissions, the request will be automatically approved.

If the OEM service engineer's account or user group does not yet have a pre-approved remote access permission for equipment, the OEM service engineer can still make a request for remote access, however the request will first need to be approved. Based on predefined workflows, the central user portal will start the approval process, which will typically involve approvals from both OEM and FAB security officers. Once approval has been granted, the OEM service engineer receives a link (URL), wherein access to the Edge Portal will be made available and the connectivity between the OEM engineer device and the FAB Edge Portal may be enabled via the Zero-trust configuration. An OEM service engineer can use the remote access service anywhere where HTTPS public internet connectivity is available.

When the OEM engineer accesses the equipment certain remote access options may be offered. One remote service option is web proxy. This option allows the OEM service engineer to view and select links to web contents that are hosted on the equipment. In one embodiment, only the links that are explicitly authorized may be shown. Another remote service option is a commands option. The commands option allows the OEM service engineer to request the execution of specific secure shell commands on the equipment. In one embodiment, only the commands that are explicitly authorized may be executed.

Remote Take-Over (RTO) may also be offered. RTO may be active or passive. When RTO is passive, this option enables a view-only RTO connection to the equipment. When RTO is active, this option enables an RTO Connection to the equipment enabling command execution for authorized commands. Remote Take Over (RTO) allows the OEM engineer to take over the front-end (screen) of a machine located in a FAB. The RTO is realized using remote management tools such as Virtual Network Computing (VNC) and Remote Desktop Protocol (RDP).

An additional remote access option is file browsing. This option provides the OEM service engineer with the option to browse specific folders on the equipment and to upload or download files to or from the equipment. In one embodiment, only the folders and files that are explicitly authorized will be shown. An additional service provided by the Connectivity platform is file transfer. File Transfer allows the OEM engineer to transport files to and from the FAB. Files transported from the FAB may include log files and anonymized data files. Files transported to the FAB may include machine configuration data and software packages, updates, and patches.

In one embodiment, an authorized user makes a file transfer request through the central user portal. The request may specify scheduled or on-demand transfers. If a request is made for a file for which the authorized user or the user's user group does not have pre-approved permission, then the request will require approval. The request will also require approval if it concerns a repetitive schedule. Based on predefined workflows, the central user portal will start the approval process, which may involve approvals from both OEM and FAB security officers. After approval has been granted, the request will be handled by the file transfer scheduler capability of Connectivity platform. This will generate the triggers for the actual file transfer(s) as stipulated in the request's schedule. It will also be possible for the user to see the list of file transfers scheduled in the future.

In one embodiment, each file transfer trigger is sent to the FAB Edge instance for execution. The FAB Edge relies on the trigger coming from the central user portal and does not allow a user to interfere or interact with the trigger. Once the trigger is received by the FAB Edge instance, file transfer is handled automatically. For a ‘Get’ request, the files are downloaded from the equipment to the FAB Edge instance, where they can be inspected by the FAB security officer or FAB administrator. Following inspection, if the file is released, it will be sent via a secure connection to a file landing zone at the OEM. For a ‘Put’ request, the files are retrieved from the file landing zone at the OEM and sent to the FAB Edge instance, where they can be further uploaded automatically onto the appropriate OEM Equipment. The file transfer capability provides visibility of transfer progress and remaining time to complete the transfer. It also offers the option to restart a transfer if it has failed. The end-to-end file transfer capability is designed to transfer files in accordance with agreed security policies.

FIG. 4a is a view of an interface 415 for the Connectivity platform. In one embodiment, the interface can list the equipment visible to the user of the Connectivity platform. Whether an equipment is visible or not is determined by the permissions and permission sets assigned to that user. The definition of permissions and the assignment of a permission set to a user triggers an approval process. Selecting one of the listed FAB equipment may preferably then create an access request that is validated and approved within the Connectivity platform. Once approved, a web link may be communicated to the user to start the RTO session and the zero-trust connectivity is configured for this connection. The same zero-trust process may be implemented for the other features, including RCE, file transfer, and remote applications. That is, the list of items that the user is authorized to request access to may be displayed, which when selected by the user initiates the access request workflow.

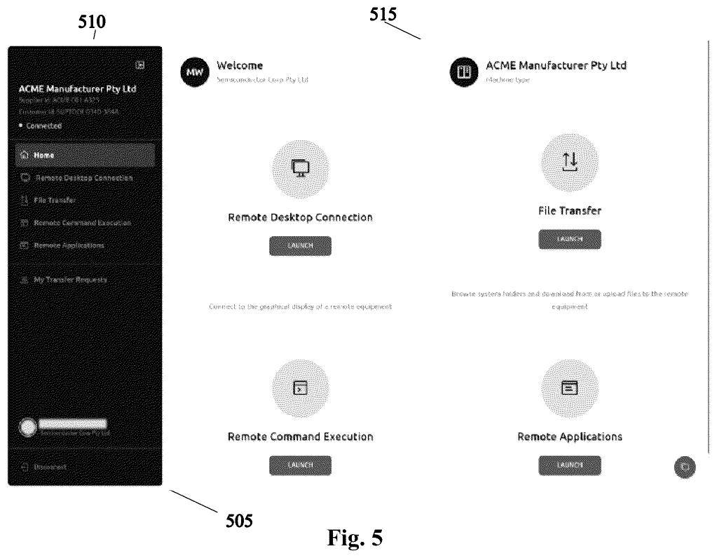

FIG. 5 is a view of an interface 505 for the Connectivity platform. In one embodiment, the interface can be presented in a panel 510 and quadrant 515 presentation. It should be understood by those having skill in the art that the interface may be customizable to the preferences of the OEM engineers accessing the portal, as well as the OEM and FAB security officers authorizing access to particular equipment. In the embodiment illustrated in FIG. 5, the features of the Connectivity platform are presented in each quadrant, for example, remote desktop connection, file transfer, remote command execution and remote applications. While other functionality may also be presented, the above are noted for illustrative purposes. In one embodiment, the Connectivity platform interface in FIG. 5 illustrates a web-based portal at the FAB Edge that OEM service engineers may access to interact with FAB equipment. The interface may be populated based on permissions/rights, including with selectable maps, dropdown menus, etc. . . . In this instance, the user has access to the four features displayed. As discussed above, even when access is granted, the user may be limited with respect to only certain applications, file types, commands, or other criteria.

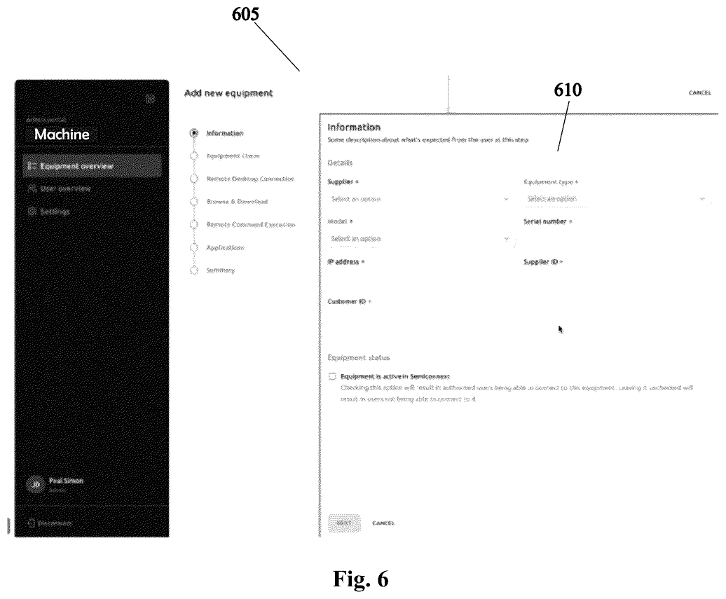

FIG. 6 is a view of an admin interface 605 for the Connectivity platform. In one embodiment, the admin portal interface can be presented in a panel and form 610 presentation. The form generally allows users to add new equipment and define the relevant data for that equipment, including OEM supplier, model, equipment type, serial number, IP address, etc. It should be understood by those having skill in the art that the interface may be customizable to the preferences of the FAB administrators managing the portal. The admin portal may provide administrators the ability to perform administrative tasks such as disabling certain types of remote access, adding new equipment, changing permissions, and the like.

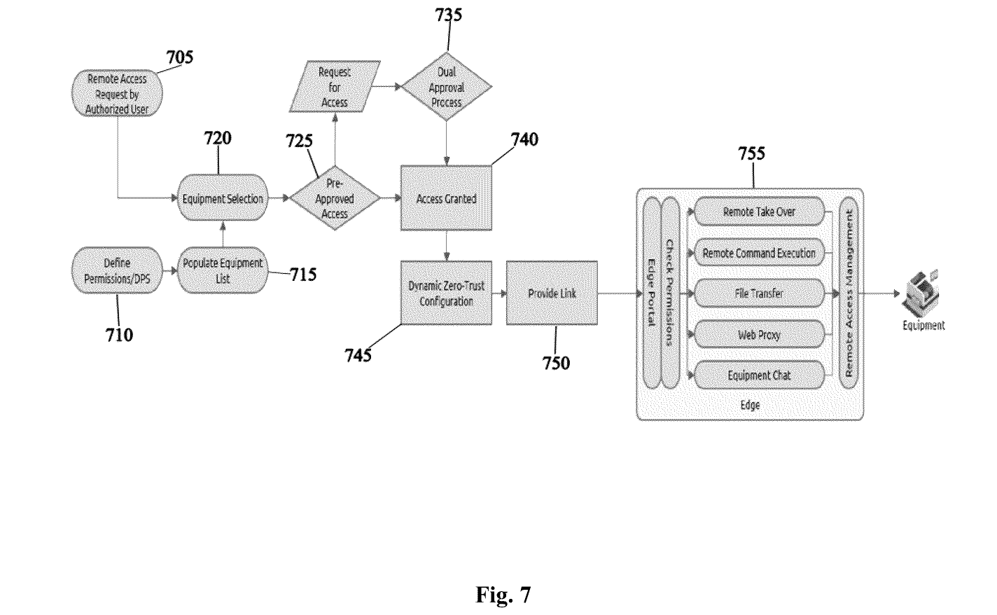

FIG. 7 is an example flow diagram of the Connectivity platform. In one embodiment, the remote access request 705 is made by an authorized user. An authorized user is generally one that has been authenticated, for example, based on account and password matching. As discussed above, the user may be presented with a first interface that provides the user with the features that that user may access. In one embodiment, the platform provides an RTO feature, which generally allows OEM users to control the remote FAB equipment.

Upon authentication, the Connectivity platform may define permissions 710 or permission bundles may be aggregated to defined permissions sets. Based on those permissions, an equipment list may be populated 715. From there, the user may be presented with an opportunity to select equipment 720. If access to the equipment is pre-approved 725, access is granted 740 and a link is sent to the user for access to the equipment through the central user portal. If pre-approved access has not been provided, the flow will then turn to a dual approval process 735 where the OEM and/or FAB side security officers/chaperones will approve access to that particular user. Once access is granted through the dual approval process, a link is sent to the user and access is granted 740. While providing the link 750, both the user network endpoint as well as the edge portal are configured dynamically for a zero-trust connection 745 to be established between these two network endpoints. In one embodiment, the user may have access to one or more features or functions for that specific piece of equipment, which allow them to interact with the equipment. The permission to access certain functions is enforced at the edge portal 755. For example, the functions available to the user may include RTO, RCE, file transfer, web proxy and equipment chat. The functions are then executed by a remote execution management and only that engine connects to the equipment itself.

In one embodiment, the OEM user portal acts as a galvanic separation that displays the interface of the machine that the user wants to control (view only). The chaperone device preferably sees the same screen that the OEM user sees. That is, a video stream of the interface at the remote equipment is duplicated by the middleware and communicated to both the OEM and chaperone users. Preferably, the video stream is relayed by the middleware only. That is, the video stream is not stored by the middleware.

The chaperone may then get a notice to promote the OEM user from view only to remote access. Once granted by the chaperone, the OEM user takes over the remote equipment, operating it as if the OEM user is physically on the machine being controlled. That is, the OEM user enters input at his/her device, which is sent to and translated by the middle software, and finally relayed to the remote equipment for the remote equipment to respond according to the input. Because the OEM user is not directly connected to the equipment, the middleware/chaperone may terminate and/or demote the session to a view only state. Importantly, because there is no direct connection, the OEM user is unable to run script or commands on the remote equipment, for example, without that script/command being seen by the middleware. Indeed, the middleware being situated as it is, is able to monitor every bit/byte in and out of the FAB equipment, allowing the fine-grained privileges and control discussed herein. Preferably, all decisions are logged for auditing in a mutable way.

Accordingly, the intermediary/chaperone has the ability to monitor actions by the OEM user with respect to the FAB equipment and respond accordingly in real time. The intermediary may include a machine learning model, for example, trained to monitor OEM actions and respond accordingly, including stopping the RTO session in whole or in part. The model may further be trained to recommend or take remedial action. For example, the model may monitor actions for potentially harmful changes to system files. In this instance, the system may prevent the changes from taking effect and/or roll back the changes, in addition to demoting access for the OEM. As discussed above, a chaperone may be employed, in which instance the chaperone is able to stop, pause, or demote the OEM user.

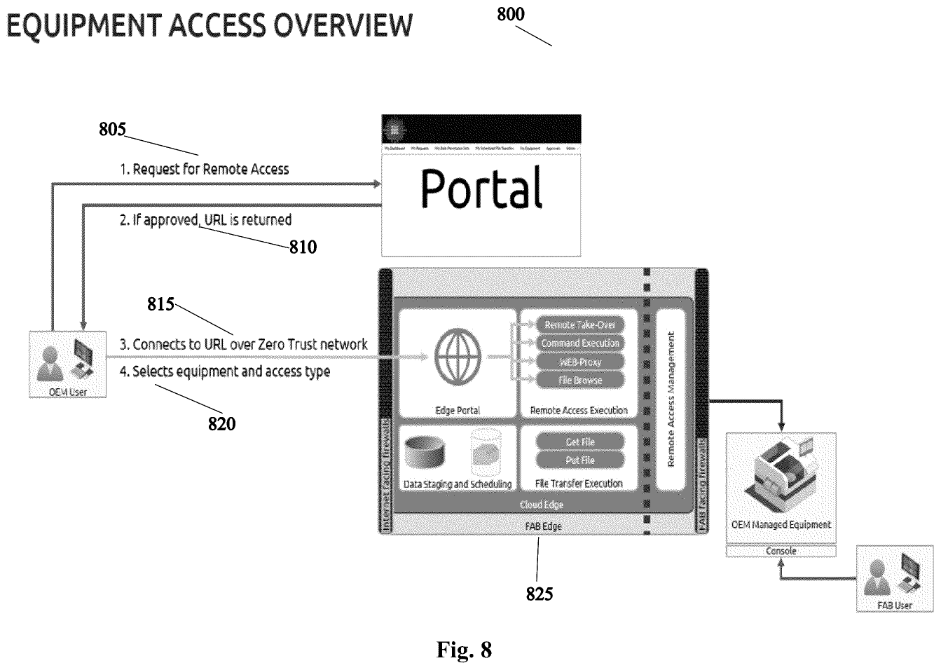

FIG. 8 is an example flow diagram 800 of the equipment access process. The example flow shows an OEM User requesting access to the User Portal 805. A determination whether access is approved 810 may be made and a URL or other type of link may be sent to the OEM User for access. The OEM User may connect over the zero-trust Network 815 to the Edge Portal via the URL or link. When the user reaches the Edge Portal 825, the OEM User may then select equipment 820 and access type. FIG. 8 further illustrates the FAB Edge and Cloud Edge between Internet facing firewalls and FAB facing firewalls for appropriate security measures. The Cloud Edge includes the Edge Portal, the Data Staging and Scheduling modules, the Remote Access Execution Functionality and the File Transfer Execution module.

The following is a description of a general network architecture followed by a description of a software defined wide area network. Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

Any node may include a processor in communication with memory. Generally, any mechanization allowing a processor to affect the storage and/or retrieval of information is regarded as memory. Any number of memory embodiments may be employed in lieu of or in concert with one another. It is to be understood that a bus controller and/or a computer systemization may employ various forms of memory. For example, a computer system may be configured wherein the operation of on-chip CPU memory (e.g., registers), RAM, ROM. In a typical configuration, memory will include ROM, RAM, and a storage device. A storage device may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blu Ray, CD ROM/RAM/Recordable (R)/ReWritable (RW), DVD R/RW, HD DVD R/RW etc.); RAM drives; non-transient memory, solid state memory devices (USB memory, solid state drives (SSD), etc.); other processor-readable storage mediums; and/or other devices of the like.

The Connectivity platform relies on network connectivity between the OEM and the FAB. There are three illustrative ways connectivity may be established. First, connectivity may be established through the internet via the OEM Internet Service Provider (ISP) and the FAB ISP. Second, connectivity may be established through the OEM ISP and FAB ISP with a zero-trust layer on top. Third, connectivity may be established through an SD-WAN layer.

With respect to the zero-trust connectivity layer, for remote access, the OEM engineer issues a request over the public Internet to the central user portal, which triggers an approval workflow. Once the request has been approved, and the OEM engineer is provided with a link to access the FAB Edge, the traffic does not flow through the public Internet anymore, but through a network overlay for enhanced security referred to as the zero-trust overlay Network (ZTON). As opposed to the network traffic between the Connectivity orchestration layer and the Edges, the remote access scenario can originate from anywhere. This could be convenient for example if an OEM engineer is on travel. In one embodiment, it is possible to white-list source IP addresses corresponding to predefined ranges, e.g., corresponding to the OEM corporate network if desired. The ZTON may be accessed through so-called Public Service Edge Nodes (PSEN).

The network underlay is a virtual network that uses software-defined networking to distribute traffic across a wide area network. A network underlay may be utilized to connect branch offices to data centers and cloud-based applications. Network underlays are more flexible and cost-effective than traditional routing. They can use multiple connection types, including MPLS, LTE, and broadband internet. Network underlays can also improve network redundancy, bandwidth, and performance. Network underlays are different from VPNs because network underlays have multiple paths to choose from when routing traffic. VPNs only use one path. Network underlays are also different from firewalls. Firewalls enforce rules to determine the security of incoming and outgoing network traffic. Network underlays direct traffic through the best available route.

The functionality provided by the network underlay in the Connectivity platform may include Next Gen Firewall: The network underlay provides Next Gen firewall Capabilities on top of the network data transport layer. Network traffic into and out from the FAB and OEM is scanned for malicious content at the network and application layer. The data itself (the intellectual property) is not read nor stored. Network Security: network underlay creates secure IPsec tunnels over the underlay network. These tunnels guarantee secure point to point network connections between FAB, OEM and the Connectivity platform. Routing: The network underlay layer provides the routing capability to route network traffic towards the different destinations, such as OEM, FAB and the Connectivity platform.

In case multiple underlay networks are available the configuration provides the option to define redundant routes. A specific underlay network can be defined as the primary route for the network traffic (e.g., an internet connection), a secondary route can be defined over a different Underlay network (e.g., a 5G mobile network). The network underlay will automatically switch to the secondary network in case of unavailability of the primary network. Thus, providing a higher availability level of network connections.

The network underlay layer can provide QoS to the network. Specific network traffic flows can be prioritized over other, less important network flows. The QoS profiles are configured on the outset of an OEM on-boarding taking into account the KPIs relevant for the “T-Shirt” sizes identified. Their ongoing management is subject to provider change control mechanisms and capacity management routines described in the operational process of the Provider. Multi-OEM based configurations are constructed on the outset of a new OEM, based upon agreed KPIs and are bound to source and destination network schemas such that traffic bandwidth is harmonized between OEMs. This may drive additional capacity should a situation arise in OEM on-boarding that the new requirements exceed the already committed capacity granted over an existing QoS policy.

Flexibility and automation: The above features may be provided in a completely automated manner and are orchestrated via the central SD-WAN management. This automation ensures a more robust and stable network. Automation creates a high degree of flexibility and scalability in the network.

The network underlay connectivity layer is described as follows. When the Central User Portal instructs the Connectivity core orchestration layer, e.g., to initiate an approval workflow, the communication flows through a reliable and secure Network Overlay. When the Connectivity core orchestration layer subsequently instructs the Edge to execute further parts of the workflow, that network underlay network will be used too. It will also be used when the Edge needs to transfer data, logs for example, back to the Core Platform. In one embodiment, the connections are terminated at the core platform and at the edges in dedicated network underlay appliances.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A method for managing a zero-trust architecture, comprising:
receiving a remote access request from a user;
determining a defined set of permissions associated with the user;
populating an equipment list of selectable equipment for the user;
selecting at least one piece of equipment from the equipment list;
initiating a dual approval process for the selected piece of equipment;
granting access to a central user portal through a zero-trust configuration by transmitting a link to the user; and
remotely accessing the selected piece of equipment via the edge portal through the zero-trust configuration.

2. The method for managing the zero-trust architecture of claim 1, comprising:
defining an access permission and a transfer permission by an original equipment manufacturer.

3. The method for managing the zero-trust architecture of claim 1, comprising:
presenting the central user portal as a panel interface and a quadrant interface.

4. The method for managing the zero-trust architecture of claim 1, comprising:
receiving an original equipment manufacturer approval and a fabrication side approval as part of the dual approval process.

5. The method for managing the zero-trust architecture of claim 1, wherein the zero-trust configuration includes providing a fabrication edge access link to the user and wherein communications traffic flows through a network overlay.

6. The method for managing the zero-trust architecture of claim 5, wherein the network overlay includes a plurality of public service edge nodes.

7. The method for managing the zero-trust architecture of claim 6, wherein the network overlay is a virtual network utilizing a plurality of connection types to provide a plurality of pathways for routing network traffic.

8. The method for managing the zero-trust architecture of claim 5, comprising:
creating secure internet protocol security tunnels guaranteeing secure point to point network connections between a fabrication edge, an original equipment manufacturer edge and a connectivity platform.

9. The method for managing the zero-trust architecture of claim 5, wherein the network underlay includes a plurality of network underlays providing a primary traffic route and a secondary traffic route.

10. The method for managing the zero-trust architecture of claim 1, wherein the central user portal includes an architecture administering access to a plurality of services including an authentication service, a remote take over service, a file transfer service, a security management service and an auditing service.

11. A system for managing a zero-trust architecture, comprising:
a connectivity platform including an original manufacturer side, and a fabrication side connected via a network;
a central user portal facilitating communication between the original manufacturer side and the fabrication side via the connectivity platform;
an original equipment manufacturer network integrated with the original manufacturer side and the connectivity platform, the original equipment manufacturer network providing a user a plurality of connectivity options to facilitate communications with the fabrication side;
a fabrication network integrated with the fabrication side and the connectivity platform, the fabrication network providing the user with a galvanically separated access to one or more pieces of fabrication equipment.

12. The system of managing the zero-trust architecture of claim 11, wherein the connectivity platform provides an original equipment manufacturer side user remote access to the fabrication side by establishing a network connection between an original equipment manufacturer internet service provider and a fabrication internet service provider.

13. The system of managing the zero-trust architecture of claim 11, wherein the original equipment manufacturer side includes an original equipment manufacturer edge.

14. The system of managing the zero-trust architecture of claim 13, wherein the original equipment manufacturer edge includes a file store and a transfer scheduler.

15. The system of managing the zero-trust architecture of claim 14, wherein the original equipment manufacturer edge includes a self-managed landing zone for one or more file transfers from the fabrication side.

16. The system of managing the zero-trust architecture of claim 11, wherein the fabrication side includes an fabrication edge.

17. The system of managing the zero-trust architecture of claim 11, wherein the fabrication edge includes an edge portal, a remote take over module, a remote command execution module a file transfer module, a web proxy module and an equipment chat module.

18. The system of managing the zero-trust architecture of claim 16, wherein the fabrication edge includes a dual configuration, the dual configuration including a physical fabrication edge and a cloud based fabrication edge.

19. The system of managing the zero-trust architecture of claim 11, wherein the central user portal includes a plurality of modules including an authentication module, a zero-trust connectivity module, a remote take over module and a file transfer module.

20. The system of managing the zero-trust architecture of claim 19, wherein the central user portal includes an administration module managing one or more requests from the plurality of modules through the connectivity platform.
